(19) United States
(12) Patent Application Publication
(10) Pub. No.: US 2001/0054011 A1
(43) Pub. Date: Dec. 20, 2001

(54) Contents conversion fee charging system, contents conversion fee charging method and storage medium storing program for controlling same

(75) Inventors: Kyoko Kimpara, Tokyo (JP); Mitsugu Miura, Tokyo (JP)

Correspondence Address: SUGHRUE, MION, ZINN, MACPEAK & SEAS, 2100 Pennsylvania Avenue, N.W., Washington, DC, 20037-3202, US

(73) Assignee: NEC CORPORATION

(21) Appl. No.: 09/880,045

(22) Filed: Jun. 14, 2001

(30) Foreign Application Priority Data
Jun. 15, 2000 (JP) 180509/2000

(51) Int. Cl. G06F 17/60

(52) U.S. Cl. 705/26; 705/40

(57) ABSTRACT

There is provided a contents conversion fee charging system including: a contents provider terminal to be operated by a contents provider; a contents server to store contents provided by said contents provider; a user terminal to be operated by a user; a conversion server to convert the contents; and wherein the contents provider is charged a conversion fee for contents conversion performed by the conversion server.

The present application claims priority of Japanese Patent Application No.2000-180509 filed on Jun. 15, 2000, which is hereby incorporated by reference.

### BACKGROUND OF THE INVENTION

1. Field of the Invention

The present invention relates to a contents conversion fee charging system and a contents conversion fee charging method that can be suitably used when contents described in a foreign language on a homepage are converted into those in a native language and a storage medium storing programs for controlling the above system and method.

2. Description of the Related Art

When contents are described in a foreign language (for example, in English) on a homepage on the Internet, in many cases, contents described in the foreign language are translated (that is, language-converted) into those described in a native language (for example, in Japanese) of a user who wants to refer to the contents on the homepage. In such a case, in a conventional contents translation (conversion) fee charging system, the user has to bear a fee for translation of the contents. FIG. 3 is a schematic block diagram showing configurations of the conventional contents translation fee charging system. As shown in FIG. 3, such the conventional contents translation fee charging system includes a contents server 10, a contents translating server 30 and a user terminal 20. The contents server 10 is used to store and transmit contents 11 provided by a contents provider. The user terminal 20 is used to make a request of a contents translating server 30 for translating contents selected out of contents stored in the contents server 10 and displayed by the user. The user terminal 20 displays translated contents 21.

The contents translating server 30 has a user registering device 31, a user information registered database (hereinafter, referred to as a “user information registered DB 32”), a translation request controlling device 33, a database reference controlling device (hereinafter referred to as a “DB reference controlling device” 34), a translation processing device 35, a translation processing storing device 36, and a translation fee calculating/notifying device 37. The user registering device 31 is used to register user information (such as a person to be charged for translation fee, payment time, settlement method or a like). In the user information registered DB 32 is registered the user information. The translation request controlling device 33 receives translation implementing request information in accordance with a URL (Uniform Resource Locator) instruction from the user terminal 20, investigates the user information registered DB 32 to check whether the user is a registered one or not and, if the user is the registered one, acquires contents 11 and instructs the translation processing device 35 to perform the translation and transmits translation results to the user terminal 20. The DB reference controlling device 34, in response to a request from the translation request controlling device 33, checks whether the translation implementing request information is information stored in the user information registered DB 32 and, if the above information exists in the user information registered DB 32, permits the translation request controlling device 33 to translate the contents 11. The translation processing device 35 performs translation on the contents 11 and transmits results from the translation of the contents 11 to the translation request controlling device 33. After translation is completed, the translation request controlling device 33 records a fact that a URL has been translated as use history information on the translation processing storing device 36. The translation fee calculating/notifying device 37 calculates the translation fee by referring to the user information registered DB 32 and the translation processing storing device 36 and notifies the user terminal 20 of a request for payment.

In the conventional contents translation fee charging system, the contents 11 provided by the contents provider are stored in the contents server 10 and transmitted to the contents translating server 30 in response to the request from the contents translating server 30. Moreover, the contents stored in the contents server 10 are displayed on the user terminal 20 by manipulation of the user and are translated by the contents translating server 30. At this point, translation implementing request information is transmitted to the translation request controlling device 33 in accordance with a URL fed from the user terminal 20. Based on this translation implementing request information, the user information registered DB 32 is referred to through the DB reference controlling device 34 and, if a user is a registered user, a permission for translation of the contents 11 is given to the translation request controlling device 33 and the translation processing device 35 is instructed to perform translation on the contents 11. The contents 11 is translated by the translation processing device 35 and the translated contents 21 are transmitted through the translation request controlling device 33 to the user terminal 20. The translated contents 21 are displayed on the user terminal 20. After translation is completed, the translation request controlling device 33 records a fact that a URL has been translated as use history information on the translation processing storing device 36. The user information registered DB 32 and the translation processing storing device 36 is referred to by the translation fee calculating/notifying device 37 and the translation fee is calculated by the translation fee calculating/notifying device 37 and a payment request is notified to the user terminal 20. The user is charged for the translation fee.

However, the above-described conventional contents translation fee charging system has following problems. That is, even if a contents provider such as a company has a will to convert the contents even by paying the translation fee, that is, to translate contents described in a foreign language into contents described in a native language of a user, the user being a customer has to bear costs of the translation, for example, the translation. The system in which the user is charged for the translation fee and the translation fee has to be collected from the user is accompanied by inconvenience such as an increase in costs and risks. The inconvenience includes points, for example, that it is difficult for a user to construct an accounting system to count the number of times of use of the contents translating server 30, it is difficult to construct a low cost charging system of the translation fee, a fee for a settlement of amounts to be paid by a credit card of the user is necessary, it costs much to hold and store a large amount of personal information of the user and it costs much to bill the user for the translation fee that has not been collected yet. Moreover, even if a contents provider has a will to translate contents described in a foreign language on a homepage by paying the translation fee and to display them, it is difficult to eliminate the possibility of infringing on a copyright of original contents. When the user uses the contents translation fee charging system, it is necessary to designate the URL that the contents employ, which takes much time and labor.

### SUMMARY OF THE INVENTION

In view of the above, it is an object of the present invention to provide a contents conversion fee charging system and a contents conversion fee charging method in which a user is not charged for a contents conversion fee, but a contents provider is charged.

According to a first aspect of the present invention, there is provided a contents conversion fee charging system including:

a contents provider terminal to be operated by a contents provider;

a contents server to store contents provided by the contents provider;

a user terminal to be operated by a user;

a conversion server to convert the contents; and

wherein the contents provider is charged for a fee for contents conversion performed by the conversion server.

In the foregoing first aspect, a preferable mode is one wherein, in the conversion, the contents, when being described in a foreign language, are translated into contents described in a native language of a user.

According to a second aspect of the present invention, there is provided a contents conversion fee charging system including:

a contents provider terminal;

a contents server;

a user terminal;

a conversion server; and

wherein the contents provider terminal is so configured as to provide the contents server with contents to be converted, and to provide the conversion server with contents information containing at least URL (Uniform Resource Locator) information about the contents and contents provider information showing a method of charging for conversion of the contents, such that the contents information and contents provider information are registered on the conversion server, and to receive conversion fee information about conversion of the contents from the conversion server,

wherein the contents server is so configured as to store the contents provided by the contents provider, and to transmit stored the contents to the conversion server by request of the conversion server based on an instruction of a conversion instruction banner,

wherein the user terminal is so configured as to select and display the contents stored in the contents server, to transmit to the conversion server conversion implementing request information used to make a request of the conversion server for conversion of the contents displayed in accordance with the instruction of the conversion instructing banner and to input and display results of conversion of the contents,

and wherein the conversion server is so configured as to acquire and convert the contents to be converted from the contents server, based on the conversion implementing request information and to transmit the results of conversion of the contents to the user terminal, and to produce conversion fee information by calculating a conversion fee, based on both contents provider information stored in the contents registered database and use history information registered on the translation processing storing device, and to transmit the conversion fee information to the contents provider terminal in order to charge the contents provider for conversion fees.

In the foregoing second aspect, a preferable mode is one wherein the conversion server has a contents registering device, a contents registered database, a conversion request controlling device, a database reference controlling device, a conversion processing storing device, a conversion device, and a conversion fee calculating and notifying device,

wherein the contents registering device is so configured as to perform registration processing of the contents provider information, and wherein the contents registered database is so configured as to register the contents provider information,

wherein the conversion request controlling device is so configured as to refer to the contents registered database , and to acquire from the contents server contents corresponding to the conversion implementing request information, when the contents are those to be converted, by the reference, and to instruct the conversion device to perform the conversion of acquired the contents and to transmit results of the conversion of the contents performed by the conversion device to the user terminal,

wherein the database reference controlling device is so configured as to check, in response to a reference from the conversion request controlling device, whether the contents to be converted have been registered on the contents registered database and, when the contents have been registered, to permit the conversion request controlling device to perform the conversion of the contents and ,after conversion, to transmit information that the conversion has been performed to the conversion processing storing device as use history information,

wherein the conversion processing storing device is so configured as to store the use history information,

wherein the conversion device is so configured as to perform the conversion of the contents to be converted and to transmit results of the conversion to the user terminal, and

wherein the conversion fee calculating and notifying device is so configured as to produce the conversion fee information by referring to the contents registered database and the conversion processing storing device and by calculating the conversion fee and to transmit the conversion fee information to the contents provider terminal in order to charge the contents provider for the conversion fee.

Also, a preferable mode is one wherein, in the conversion, the contents, when being described in a foreign language, are translated into contents described in a native language of a user.

According to a third aspect of the present invention, there is provided a method of charging a contents conversion fee employed in a contents conversion fee charging system made up of a contents provider terminal, a contents server, a user terminal, and a conversion server, including:

contents providing processing in which the contents provider terminal provides the contents server with contents to be converted,

contents provider information registering processing in which the contents provider terminal provides the conversion server with contents information containing at least URL (Uniform Resource Locator) information about the contents and contents provider information showing a method of charging for conversion of the contents, such that the contents information and contents provider information are registered on the conversion server;

contents storing processing in which the contents server stores the contents provided by the contents provider,

contents transmitting processing in which the contents server transmits stored the contents to the conversion server by request of the conversion server based on an instruction of a conversion instruction banner,

contents displaying processing in which the user terminal selects and displays the contents stored in the contents server;

conversion request processing in which the user terminal transmits conversion implementing request information used to make a request of the conversion server for the contents displayed in accordance with an instruction of the conversion instructing banner;

converting processing in which the conversion server refers to the contents registered database and then acquires and converts the contents to be converted from the contents server, based on the conversion implementing request information, and registers information that the conversion has been performed as use history information on a storing device;,

conversion result transmitting processing in which the conversion server transmits the results of conversion of the contents to the user terminal,

conversion result displaying processing in which the user terminal inputs and displays results of conversion of the contents;

conversion fee information transmitting processing in which the conversion server produces conversion fee information by calculating the conversion fee based on both contents provider information stored in the contents registered database and use history information registered on the storing device, and transmits the conversion fee information produced to the contents provider terminal;

conversion fee information inputting processing in which the contents provider terminal inputs the conversion fee information through the conversion server; and

conversion fee charging processing in which the contents provider terminal charges the contents provider for the conversion fee, based on the conversion fee information.

In the foregoing third aspect, a preferable mode is one wherein, in the conversion, the contents, when being described in a foreign language, are translated into contents described in a native language of a user.

According to a fourth aspect of the present invention, there is provided a storage medium storing a control program to cause a computer to implement functions of a contents conversion fee charging system including:

a contents provider terminal to be operated by a contents provider;

a contents server to store contents provided by the contents provider;

a user terminal to be operated by a user;

a conversion server to convert the contents; and

wherein the contents provider is charged a conversion fee for contents conversion performed by the conversion server.

According to a fifth aspect of the present invention, there is provided a storage medium storing a control program to cause a computer to implement functions of a contents conversion fee charging system including:

a contents provider terminal;

a contents server;

a user terminal;

a conversion server; and

wherein the contents provider terminal is so configured as to provide the contents server with contents to be converted, and to provide the conversion server with contents information containing at least URL (Uniform Resource Locator) information about the contents and contents provider information showing a method of charging for conversion of the contents, such that the contents information and contents provider information are registered on the conversion server, and to receive conversion fee information about conversion of the contents from the conversion server,

wherein the contents server is so configured as to store the contents provided by the contents provider, and to transmit stored the contents to the conversion server by request of the conversion server based on an instruction of a conversion instruction banner,

wherein the user terminal is so configured as to select and display the contents stored in the contents server, to transmit to the conversion server conversion implementing request information used to make a request of the conversion server for conversion of the contents displayed in accordance with the instruction of the conversion instructing banner and to input and display results of conversion of the contents,

and wherein the conversion server is so configured as to acquire and convert the contents to be converted from the contents server, based on the conversion implementing request information and to transmit the results of conversion of the contents to the user terminal, and to produce conversion fee information by calculating a conversion fee based on both contents provider information stored in the contents registered database and use history information registered on the conversion processing storing device, and to transmit the conversion fee information to the contents provider terminal in order to charge the contents provider for conversion fees.

With the above configurations, a contents provider such as a company bears costs of a conversion and therefore it is not necessary to charge a user for a conversion fee. Since a personal user is not charged for the conversion fee but a contents provider is charged for it, costs and risks in charging the conversion fee can be reduced. Moreover, when a database reference controlling device, when contents acquired by a conversion request controlling device have been registered on a contents registered database, permits the conversion request controlling device to convert contents, a danger of an infringement on a copyright by the user can be eliminated. Furthermore, conversion of the contents is designated by the contents provider; and therefore an operation of a user of the contents conversion fee charging system is not required, which provides simple and easy operability of the contents conversion fee charging system.

### BRIEF DESCRIPTION OF THE DRAWINGS

The above and other objects, advantages, and features of the present invention will be more apparent from the following description taken in conjunction with the accompanying drawings in which:

FIG. 1 is a schematic block diagram showing configurations of a contents conversion fee charging system to implement a contents conversion fee charging method according to an embodiment of the present invention;

FIG. 2 is a flowchart explaining the contents translation fee charging method using the contents translation fee charging system of the embodiment of the present invention; and

FIG. 3 is a schematic block diagram showing configurations of a conventional contents conversion fee charging system.

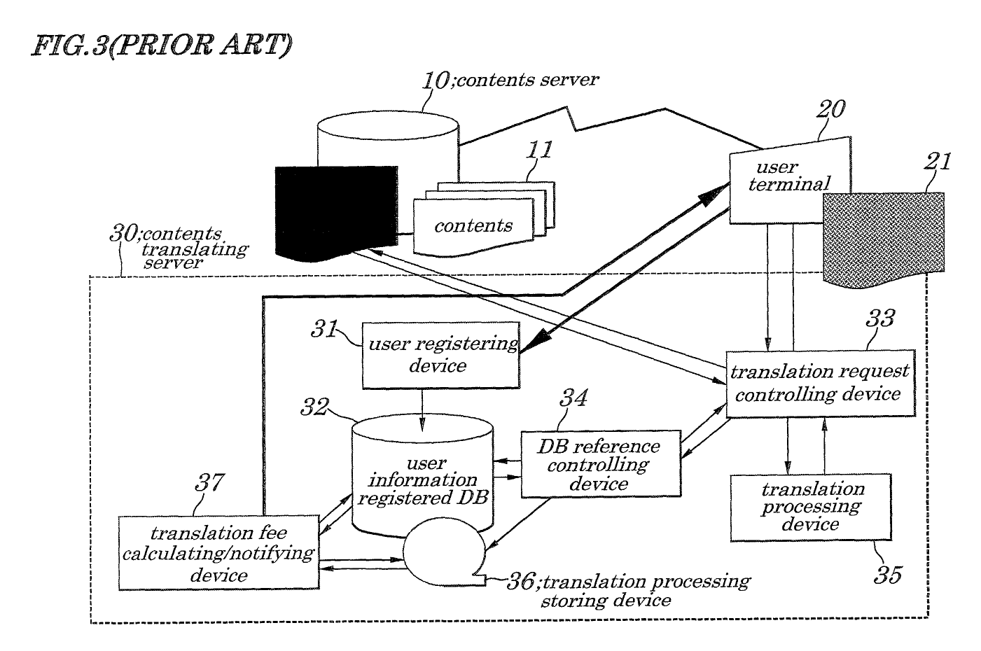

### DETAILED DESCRIPTION OF THE PREFERRED EMBODIMENTS

Best modes of carrying out the present invention will be described in further detail using various embodiments with reference to the accompanying drawings.

### First Embodiment

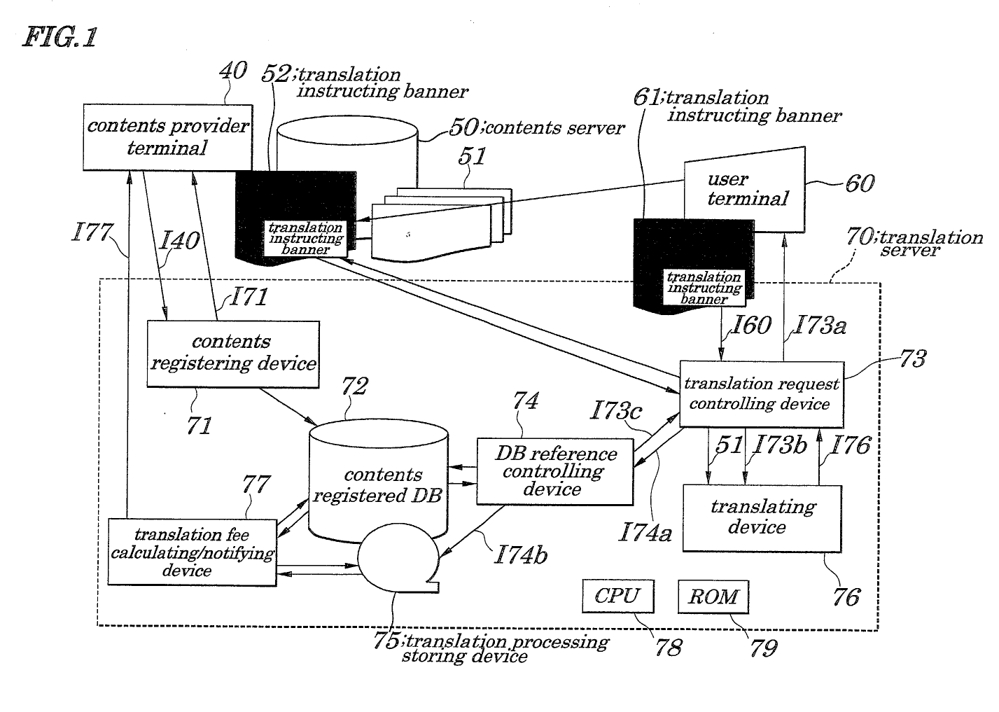

FIG. 1 is a schematic block diagram showing configurations of a contents translation fee charging system to implement a contents translation fee charging method according to an embodiment of the present invention. The conversion fee charging system of the embodiment, as shown in FIG. 1, includes a contents provider terminal 40, a contents server 50, a user terminal 60, and a translation server 70. The contents provider terminal 40 is made up of, for example, a personal computer or a like and is used to store contents 51 to be translated (for example, from English to Japanese) in the contents server 50, and to register contents information containing at least URL (Uniform Resource Locator) information about the contents 51 and contents provider information I40 showing a method of charging for translation of the contents, on the translation server 70, based on manipulation of the contents provider and inputs contents provider information I71 registered on the translation server 70 and translation fee information I77 about the contents translation, from the translation server 70. The contents server 50 stores contents 51 provided by the contents provider and transmits contents 51 to the translation server 70, by request of the conversion server 70 based on an instruction of a translation instructing banner 61. A translation instructing banner 52 is arranged and contained in the contents 51 by the contents provider, whereby the translation instructing banner 52 is acquired by user terminal 60 and displayed thereat as the translation instructing banner 61.

The user terminal 60 is made up of, for example, a personal computer or a like and is used to select and display contents 51 stored in the contents server 50, by manipulation of the user and, based on an instruction of the translation instructing banner 61, transmits translation implementing request information I60 to make a request of the translation server 70 for the translation of the displayed contents 51 to the translation server 70, and to input and display a translated result I73a of the contents 51.

The translation server 70 is made up of, for example, a work station or a like and has a contents registering device 71, a contents registered database 72, a translation request controlling device 73, a DB reference controlling device 74, a translation processing storing device 75, a translation device 76, a translation fee calculating/notifying device 77, a central processing device (CPU 78), and a storage medium (for example, ROM 79 (Read Only Memory)). The contents registering device 71 performs registration of the contents provider information I40. The contents registered DB 72 registers the contents provider information I40.

The translation request controlling device 73 refers to the contents registered DB 72, and if the contents 51 corresponding to translation implementing request information I60 proves to be those to be translated by the reference, acquires contents 51 from the contents server 50, transmits an instructing signal I73b to instruct the translating device 76 to translate the contents 51, together with the contents 51 and transmits results I76 obtained by translating the contents 51 fed from the translating device 76 to the user terminal 60.

The DB reference controlling device 74 checks, in response to a reference signal I74a fed from the translation request controlling device 73, whether the contents 51 acquired by the translation request controlling device 73 have been registered on the contents registered DB 72 and, if the contents 51 have been registered on the contents registered DB 72, transmits a permission signal I73c to permit the translation request controlling device 73 to translate the contents 51 and, after translation, information that the translation has been performed to the translation processing storing device 75 as use history information I74b. The translation processing storing device 75 stores the use history information I74b. The translation device 76 translates the contents 51 to be translated and transmits the results I76 through the translation request controlling device 73 to the user terminal 60.

The translation fee calculating/notifying device 77 transmits translation fee information I77 obtained by referring to the contents registered DB 72 and the translation processing storing device 75 and by calculating the translation fee, to the contents provider terminal 40 in order to charge the contents provider for the translation fee. The CPU 78 controls the entire translation server 70. The ROM 79 is used to store control programs to operate the CPU 78.

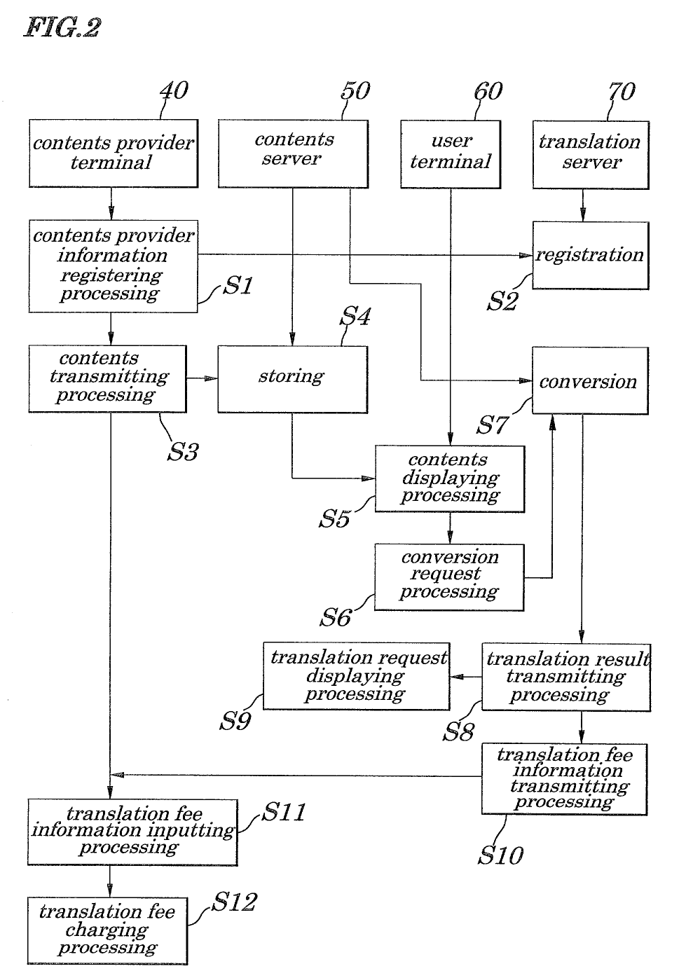

FIG. 2 is a flowchart explaining a contents translation fee charging method using the contents translation fee charging system of the embodiment of the present invention. By manipulation of the contents provider, the contents provider information I40 fed from the contents provider terminal 40 is registered on the translation server 70 (Step S1 and Step S2, contents provider information registering processing). At this point, the contents provider information I40 is registered by the contents registering device 71 on the contents registered DB 72. The contents provider information I71 registered on the translation server 70, when the translation server 70 is accessed by the contents provider, is input to the contents provider terminal 40 and is displayed. On a screen of the contents provider terminal 40 are displayed, for example, a name of an organization to which the contents provider belongs, a contact, a department to which the contents provider belongs, a name of the contents provider, a method of paying the translation fee (for example, payment ways for each site, each file, and access unit, monthly or yearly payment, advance payment/deferred payment, payment by transfer to an account/by credit card, original language of contents or a like).

The contents 51 provided by the contents provider are stored in the contents server 50 (Step S3, S4, contents storing processing). The contents 51 stored in the contents server 50 are selected at the user terminal 60 by manipulation of the user and are displayed (Step S5, contents displaying processing) and, when the contents 51 are described in a foreign language and if the user wants to refer to the contents 51 after having translated the contents 51 described in a foreign language into those described in a native language, the translation implementing request information I60 is transmitted to the translation server 70 by clicking the translation instructing banner 61 which is a specifying image area, icon or a like on a monitor screen linked to a translation instructing program (Step S6, translation request processing). The translation implementing request information I60 is input to the translation request controlling device 73.

Then, the contents registered DB 72 is referred to and if the contents 51 corresponding to the translation implementing request information I60, are those to be translated, the contents 51 are acquired from the contents server 50 by the translation server 70. Then, an instructing signal I73i b together with the contents 51 is transmitted to the translating device 76 and the contents 51 are translated (Step S7, translation processing). The translation result from the results I76 is transmitted through the translation request controlling device 73 to the user terminal 60 (Step S8, translation result transmitting processing).

At this point, in response to a reference signal I74a from the translation request controlling device 73, the contents registered DB 72 is checked by the DB reference controlling device 74 to judge whether the contents 51 which the translation request controlling device 73 intends to acquire, have been registered in the contents registered DB 72. As a result of the judgment by the DB reference controlling device 74, if the contents 51 have not been registered on the contents registered DB 72, the contents 51 are not acquired from the contents server 50, and instead, error information is transmitted from the translation request controlling device 73 to the user terminal 60 and the error is displayed at the user terminal 60. On the other hand, if the contents 51 have been registered on the contents registered DB 72, the contents 51 are acquired from the contents server 50 and the permission signal I73c is transmitted to the translation request controlling device 73 so that the contents 51 are allowed to be translated and, after translation, information that the translation has been performed is transmitted to the translation processing storing device 75 as the use history information and is then stored. The contents 51 as an object of translation are translated by the translating device 76 and the results I76 are transmitted through the translation request controlling device 73 to the user terminal 60 and is then displayed (Step S9, translation result displaying device).

The translation fee calculating/notifying device 77 produces translation fee information I77 by referring to the contents registered DB 72 and the translation processing storing device 75 and by calculating the translation fee and the obtained translation fee information I77 is transmitted to the contents provider terminal 40 (Step S10, translation fee information transmitting processing).

The translation fee information I77 is input to the contents provider terminal 40 (Step S11, translation fee information inputting processing) and the contents provider is charged for the translation fee (Step S12, translation fee charging processing).

Thus, according to the embodiment, since the contents provider such as a company bears costs of the translation fee, it is not necessary for the user to pay the translation fee. That is, the user is not charged for the translation fee but the contents provider is charged for the translation fee and, therefore, costs and risks associated with charging of the translation fees can be reduced. Moreover, the DB reference controlling device 74, when the contents 51 acquired by the translation request controlling device 73 have been registered on the contents registered DB 72, transmits the permission signal I73c to the translation request controlling device 73 and, as a result, a danger of users' infringement on a copyright is eliminated. Moreover, since the contents provider designates the translation of the contents 51, it is not necessary for the user to manipulate the contents translation fee charging system, thus achieving easy operations of the system.

It is apparent that the present invention is not limited to the above embodiments but may be changed and modified without departing from the scope and spirit of the invention. For example, contents may be translated in an arbitrary form, that is, in units of pages or sites. The method of calculating the translation fee and the payment time may be also set in an arbitrary way, that is, the translation fee may be paid, for example, by an advance lump-sum payment method for each site or by a deferred payment method for each page depending on actual results of the number of times of translations. Moreover, the translation fee may be paid in an arbitrary way, that is, by way of a transfer of amounts to be paid to a bank account or payment from the bank account, based on issuance of bills. Furthermore, in the above embodiment, the example is given in which English contents are translated into Japanese contents, however, the present invention may be applied not only to cases of the translation between languages but also to cases of translation in an image translation system used to improve quality of images and to cases of translation from an HTML (Hyper Text Markup Language) format to a WAP (Wireless Application Protocol) format.

What is claimed is:

1. A contents conversion fee charging system comprising:
a contents provider terminal to be operated by a contents provider;
a contents server to store contents provided by said contents provider;
a user terminal to be operated by a user;
a conversion server to convert said contents; and
wherein said contents provider is charged a conversion fee for contents conversion performed by said conversion server.

2. The contents conversion fee charging system according to claim 1, wherein, in said conversion, said contents, when being described in a foreign language, are translated into contents described in a native language of a user.

3. A contents conversion fee charging system comprising:
a contents provider terminal;
a contents server;
a user terminal;
a conversion server; and
wherein said contents provider terminal is so configured as to provide said contents server with contents to be converted, and to provide said conversion server with contents information containing at least URL (Uniform Resource Locator) information about said contents and contents provider information showing a method of charging for conversion of said contents, such that said contents information and contents provider information are registered on said conversion server, and to receive conversion fee information about conversion of said contents from said conversion server,
wherein said contents server is so configured as to store said contents provided by said contents provider, and to transmit stored said contents to said conversion server by request of said conversion server based on an instruction of a conversion instruction banner,
wherein said user terminal is so configured as to select and display said contents stored in said contents server, to transmit to said conversion server conversion implementing request information used to make a request of said conversion server for conversion of said contents displayed in accordance with said instruction of said conversion instructing banner and to input and display results of conversion of said contents,
and wherein said conversion server is so configured as to acquire and convert said contents to be converted from said contents server, based on said conversion implementing request information and to transmit said results of conversion of said contents to said user terminal, and to produce conversion fee information by calculating a conversion fee based on both contents provider information stored in said contents registered database and use history information registered on said conversion processing storing device, and to transmit said conversion fee information to said contents provider terminal in order to charge said contents provider for conversion fees.

4. The contents conversion fee charging system according to claim 3, wherein said conversion server has a contents registering device, a contents registered database, a conversion request controlling device, a database reference controlling device, a conversion processing storing device, a conversion device, and a conversion fee calculating and notifying device,
wherein said contents registering device is so configured as to perform registration processing of said contents provider information, and wherein said contents registered database is so configured as to register said contents provider information,
wherein said conversion request controlling device is so configured as to refer to said contents registered database, and to acquire from said contents server contents corresponding to said conversion implementing request information, when said contents are those to be converted, by the reference, and to instruct said conversion device to perform said conversion of acquired said contents and to transmit results of said conversion of said contents performed by said conversion device to said user terminal,
wherein said database reference controlling device is so configured as to check, in response to a reference from said conversion request controlling device, whether said contents to be converted have been registered on said contents registered database and, when said contents have been registered, to permit said conversion request controlling device to perform said conversion of said contents and, after conversion, to transmit information that the conversion has been performed to said conversion processing storing device as use history information,
wherein said conversion processing storing device is so configured as to store said use history information,
wherein said conversion device is so configured as to perform said conversion of said contents to be converted and to transmit results of said conversion to said user terminal, and
wherein said conversion fee calculating and notifying device is so configured as to produce said conversion fee information by referring to said contents registered database and said conversion processing storing device and by calculating said conversion fee and to transmit said conversion fee information to said contents provider terminal in order to charge said contents provider for said conversion fee.

5. The contents conversion fee charging system according to claim 3, wherein, in said conversion, said contents, when being described in a foreign language, are translated into contents described in a native language of a user.

6. A method of charging contents conversion fee employed in a contents conversion fee charging system made up of a contents provider terminal, a contents server, a user terminal, and a conversion server, comprising:
contents providing processing in which said contents provider terminal provides said contents server with contents to be converted,
contents provider information registering processing in which said contents provider terminal provides said conversion server with contents information containing at least URL (Uniform Resource Locator) information about said contents and contents provider information showing a method of charging for conversion of said contents, such that said contents information and contents provider information are registered on said conversion server;
contents storing processing in which said contents server stores said contents provided by said contents provider,
contents transmitting processing in which said contents server transmits stored said contents to said conversion server by request of said conversion server based on an instruction of a conversion instruction banner,
contents displaying processing in which said user terminal selects and displays said contents stored in said contents server;
conversion request processing in which said user terminal transmits conversion implementing request information used to make a request of said conversion server for said contents displayed in accordance with an instruction of said conversion instructing banner;
converting processing in which said conversion server refers to said contents registered database, and then acquires and converts said contents to be converted from said contents server, based on said conversion implementing request information, and registers information that said conversion has been performed as use history information on a storing device;
conversion result transmitting processing in which said conversion server transmits said results of conversion of said contents to said user terminal,
conversion result displaying processing in which said user terminal inputs and displays results of conversion of said contents;
conversion fee information transmitting processing in which said conversion server produces conversion fee information by calculating said conversion fee based on both contents provider information stored in said contents registered database and use history information registered on said storing device, and transmits said conversion fee information produced to said contents provider terminal;
conversion fee information inputting processing in which said contents provider terminal inputs said conversion fee information through said conversion server; and
conversion fee charging processing in which said contents provider terminal charges said contents provider for said conversion fee, based on said conversion fee information.

7. The method of charging contents conversion fee according to claim 6, wherein, in said conversion, said contents, when being described in a foreign language, are translated into contents described in a native language of a user.

8. A storage medium storing a control program to cause a computer to implement functions of a contents conversion fee charging system, said system comprising:
a contents provider terminal to be operated by a contents provider;
a contents server to store contents provided by said contents provider;
a user terminal to be operated by a user;
a conversion server to convert said contents; and
wherein said contents provider is charged a conversion fee for contents conversion performed by said conversion server.

9. A storage medium storing a control program to cause a computer to implement functions of a contents conversion fee charging system, said system comprising:
a contents provider terminal;
a contents server;
a user terminal;
a conversion server; and
wherein said contents provider terminal is so configured as to provide said contents server with contents to be converted, and to provide said conversion server with contents information containing at least URL (Uniform Resource Locator) information about said contents and contents provider information showing a method of charging for conversion of said contents, such that said contents information and contents provider information are registered on said conversion server, and to receive conversion fee information about conversion of said contents from said conversion server,
wherein said contents server is so configured as to store said contents provided by said contents provider, and to transmit stored said contents to said conversion server by request of said conversion server based on an instruction of a conversion instruction banner,
wherein said user terminal is so configured as to select and display said contents stored in said contents server, to transmit to said conversion server conversion implementing request information used to make a request of said conversion server for conversion of said contents displayed in accordance with said instruction of said conversion instructing banner and to input and display results of conversion of said contents, and wherein said conversion server is so configured as to acquire and convert said contents to be converted from said contents server, based on said conversion implementing request information and to transmit said results of conversion of said contents to said user terminal, and to produce conversion fee information by calculating a conversion fee based on both contents provider information stored in said contents registered database and use history information registered on said conversion processing storing device, and to transmit said conversion fee information to said contents provider terminal in order to charge said contents provider for conversion fees.
